(19) United States
(12) Patent Application Publication
(10) Pub. No.: US 2025/0148640 A1
(43) Pub. Date: May 8, 2025

(54) DISPLAY METHOD AND APPARATUS, AND DEVICE, MEDIUM, AND PROGRAM

(71) Applicant: Beijing Zitiao Network Technology Co., Ltd., Beijing (CN)

(72) Inventors: Xin WANG, Beijing (CN); Guidong WANG, Beijing (CN); Chen CHEN, Beijing (CN)

(21) Appl. No.: 18/935,026

(22) Filed: Nov. 1, 2024

(30) Foreign Application Priority Data
Nov. 3, 2023 (CN) 202311459803.9

(51) Int. Cl. G06T 7/73; G06T 19/00

(52) U.S. Cl. CPC G06T 7/74; G06T 19/006; G06T 2207/20101; G06T 2207/30204; G06T 2219/024

(57) ABSTRACT

Embodiments of the present application provide a display method and apparatus, and a device, a medium, and a program; an XR device determines data of an environment map of a physical space, and an association between a coordinate system of the environment map and a coordinate system of a virtual scene, obtains a first environment image of the physical space, and determines a first pose of the XR device under the coordinate system of the environment map according to the first environment image and the data of the environment map; calculates a second pose of the XR device under the coordinate system of the virtual scene according to the first pose and the association; and displays the virtual scene according to the second pose and the virtual scene

### CROSS-REFERENCE TO RELATED APPLICATIONS

The present application is based on and claims priority of CN application Ser. No. 20/231,1459803.9, filed on Nov. 3, 2023, the disclosure of which is incorporated by reference herein in its entirety.

### TECHNICAL FIELD

Embodiments of the present application relate to the technical field of electronic device, and in particular, to a display method and apparatus, and a device, a medium, and a program.

### BACKGROUND

Extended reality (XR) refers to combination of reality and virtuality by a computer, to create a virtual environment capable of human-computer interaction, and the XR is also a general term for multiple technologies such as virtual reality (VR), augmented reality (AR), and mixed reality (MR), and can bring “immersion” of seamless conversion between a virtual world and a real world to experiencers.

With the diversification of XR applications, a multi-person VR scene has emerged, for example, a VR “large space” scene, in which a plurality of users can use a plurality of VR devices to perform, within a same physical space, multi-person collaborative drawing, design, multi-person gaming, and other business. The VR “large space” is realized on the basis that the plurality of XR devices need sharing the same coordinate system, that is, the plurality of XR devices obtain their own poses in the same coordinate system, and each XR device renders a picture based on its own pose information.

### SUMMARY

The embodiments of the present application provide a display method and apparatus, and a device, a medium, and a program.

In a first aspect, an embodiment of the present application provides a display method, comprising:
determining data of an environment map of a physical space, and an association between a coordinate system of the environment map and a coordinate system of a virtual scene;
obtaining a first environment image of the physical space, and determining a first pose of an extended reality XR device under the coordinate system of the environment map according to the first environment image and the data of the environment map;
calculating a second pose of the XR device under the coordinate system of the virtual scene according to the first pose and the association; and
displaying the virtual scene according to the second pose and the virtual scene.

In some optional implementations, before the determining data of an environment map of a physical space, and an association between a coordinate system of the environment map and a coordinate system of a virtual scene, the method further comprises:
acquiring a plurality of second environment images of the physical space, and generating the environment map of the physical space according to the plurality of second environment images; and
determining the association between the coordinate system of the environment map and the coordinate system of the virtual scene according to an input of a user, or determining the association between the coordinate system of the environment map and the coordinate system of the virtual scene according to a preset mark identified in at least one second environment image.

In some optional implementations, the determining the association between the coordinate system of the environment map and the coordinate system of the virtual scene according to an input of a user, comprises:
determining the association between the coordinate system of the environment map and the coordinate system of the virtual scene according to a first point in the physical space determined by the user.

In some optional implementations, the determining the association between the coordinate system of the environment map and the coordinate system of the virtual scene according to a first point in the physical space determined by the user, comprises:
determining the association between the coordinate system of the environment map and the coordinate system of the virtual scene according to the first point and a direction in the physical space determined by the user;
or, determining the association between the coordinate system of the environment map and the coordinate system of the virtual scene according to the first point and a second point in the physical space determined by the user.

In some optional implementations, a physical mark is provided at the first point in the physical space, or the first point in the physical space is a corner point.

In some optional implementations, the virtual scene is matched with the physical space.

In some optional implementations, after the calculating a second pose of the XR device under the coordinate system of the virtual scene according to the first pose and the association, the method further comprises:
sending the second pose, so that another device in the physical space displays a virtual object corresponding to the XR device according to the second pose.

In some optional implementations, after the determining the association between the coordinate system of the environment map and the coordinate system of the virtual scene according to an input of a user, the method further comprises:
sending the association to another device in the physical space, so that the other device determines its pose under the coordinate system of the environment map according to the association and the environment image of the physical space.

In some optional implementations, the data of the environment map comprises three-dimensional coordinates of feature points in the environment map, pixel coordinates of the feature points, and descriptors of the feature points; and
the determining a first pose of the XR device under the coordinate system of the environment map according to the first environment image and the data of the environment map, comprises:
extracting feature points in the first environment image, and calculating descriptors of the feature points in the first environment image;
matching the descriptors of the feature points in the first environment image with the descriptors of the feature points in the environment map; and
performing pose solution according to three-dimensional coordinates, pixel coordinates in the first environment image, and pixel coordinates in the environment map of matched feature points, to obtain the first pose of the XR device under the coordinate system of the environment map.

In some optional implementations, the XR device performs the pose solution by using a perspective-n-point PnP algorithm.

In some optional implementations, the generating the environment map of the physical space according to the second environment image, comprises:
extracting feature points in the second environment image, determining pixel coordinates of the feature points, and calculating descriptors of the feature points;
calculating three-dimensional coordinates of the feature points according to the pixel coordinates of the feature points; and
establishing the environment map according to the pixel coordinates, the descriptors and the three-dimensional coordinates of the feature points.

In another aspect, an embodiment of the present application provides a display apparatus, comprising:
a first determination module, configured to determine data of an environment map of a physical space, and an association between a coordinate system of the environment map and a coordinate system of a virtual scene;
a second determination module, configured to obtain a first environment image of the physical space, and determine a first pose of an extended reality XR device under the coordinate system of the environment map according to the first environment image and the data of the environment map;
a third determination module, configured to calculate a second pose of the XR device under the coordinate system of the virtual scene according to the first pose and the association; and
a display module, configured to display the virtual scene according to the second pose and the virtual scene.

In another aspect, an embodiment of the present application provides an XR device, comprising: a processor and a memory, the memory being configured to store a computer program, the processor being configured to call and run the computer program stored in the memory to perform the method according to any of the above.

In another aspect, an embodiment of the present application provides a computer-readable storage medium for storing a computer program, the computer program causing a computer to perform the method according to any of the above.

In another aspect, an embodiment of the present application provides a computer program product, comprising a computer program which, when executed by a processor, implements the method according to any of the above.

### BRIEF DESCRIPTION OF THE DRAWINGS

In order to more clearly illustrate the technical solutions in the embodiments of this invention, the drawings to be used in the description of the embodiments are briefly introduced below, and it is obvious that the drawings in the description below are only some embodiments of this invention, and for one of ordinary skill in the art, other drawings can be obtained according to these drawings without paying creative labor.

FIG. 1 is a schematic diagram of a multi-person VR scene applicable to an embodiment of the present application;

FIG. 2 is a flow diagram of a display method according to a first embodiment of the present application;

FIG. 3 is a signaling flow diagram of a display method according to a second embodiment of the present application;

FIG. 4 is a schematic structural diagram of a display apparatus according to a third embodiment of the present application;

FIG. 5 is a schematic structural diagram of an XR device according to a fourth embodiment of the present application.

### DETAILED DESCRIPTION

The technical solutions in the embodiments of this invention will be clearly and completely described below in conjunction with the drawings in the embodiments of this invention, and it is obvious that the described embodiments are only part of the embodiments of this invention, rather than all of the embodiments. All other embodiments, which are obtained by one of ordinary skill in the art without making any creative labor based on the embodiments in this invention, fall within the scope of protection of this invention.

It should be noted that the terms “first,” “second,” and the like in the description and claims of this invention as well as the above drawings are used for distinguishing similar objects and not necessarily for describing a specific sequence or order. It should be understood that the data so used can be interchanged under appropriate circumstances, such that the embodiments of this invention described herein can be implemented in other sequences than those illustrated or described herein. Moreover, the terms “include” and “have” as well as any variations thereof, are intended to cover a non-exclusive inclusion, for example, a process, method, system, article or server that comprises a list of steps or units is not necessarily limited to those steps or units expressly listed, but may include other steps or units not expressly listed or inherent to such process, method, article, or device.

An embodiment of the present application provides a display method, which may be applied to an XR device, including but not limited to a VR device, AR or MR device.

VR: is a technology for creating and experiencing a virtual world, to calculate and generate a virtual environment, is multi-source information (the virtual reality mentioned herein at least includes visual perception, and can also include auditory perception, touch perception, motion perception, and even taste perception, olfactory perception and the like), achieves a fused and interactive three-dimensional dynamic visual scene of the virtual environment and simulation of entity behaviors, such that the user is immersed into the simulated virtual reality environment, and achieves applications in various virtual environments such as map, game, video, education, health care, simulation, collaborative training, sales, assisted manufacturing, maintenance and repair.

AR: AR scenery refers to a simulated scenery where at least one virtual object is overlaid over a physical

scenery or representation thereof. For example, an electronic system may have an opaque display, and at least one imaging sensor for capturing images or videos of a physical scenery, which are representations of the physical scenery. The system combines the images or videos with a virtual object and displays the combination on the opaque display. An individual indirectly views the physical scenery using the system via the images or videos of the physical scenery and observes the virtual object overlaid over the physical scenery. When the system captures images of the physical scenery by using one or more image sensors and presents the AR scenery on the opaque display by using those images, the displayed images are referred to as video transparent transmission. Alternatively, an electronic system for displaying an AR scenery may have a transparent or translucent display through which an individual may directly view a physical scenery. The system may display a virtual object on the transparent or translucent display such that the individual observes the virtual object overlaid over the physical scenery by using the system. For another example, a system may include a projection system that projects a virtual object into a physical scenery. The virtual object may be projected, for example, on a physical surface or as a hologram, such that an individual observes the virtual object overlaid over the physical scenery by using the system. Specifically, it is a technique for calculating a camera attitude parameter of a camera in a reality world (also called a three-dimensional world, or a real world) in real time in a process of the camera acquiring an image, and adding a virtual element on the image acquired by the camera according to the camera attitude parameter. The virtual element includes, but is not limited to: an image, video, and three-dimensional model. The goal of the AR technology is to socket, on a screen, a virtual world over a reality world for interaction.

MR: by presenting virtual scene information in a reality scene, establishing an information loop for interacting feedback among a real world, a virtual world, and a user, so as to enhance reality of user experience. For example, a computer-created sensory input (e.g., a virtual object) and a sensory input from a physical scenery or a representation thereof are integrated in a simulated scenery; in some MR sceneries, the computer-created sensory input may adapt to a change in the sensory input from the physical scenery. In addition, some electronic systems for presenting the MR scenery may monitor an orientation and/or position with respect to the physical scenery, to enable the virtual object to interact with a real object (i.e., a physical element from the physical scenery or a representation thereof). For example, the system may monitor motion such that a virtual plant appears to be stationary with respect to a physical building.

The virtual reality device refers to a terminal for realizing a virtual reality effect, which may be generally provided in a form of glasses, a head mount display (HMD for short), or contact lenses, for realizing visual perception and other forms of perception; of course, the form of the virtual reality device is not limited thereto, but can be further miniaturized or large-scaled according to actual needs.

Optionally, the virtual reality device (i.e., XR device) described in the embodiment of the present application may include, but is not limited to, the following types:
(1) A mobile virtual reality device, that supports the setting of a mobile terminal (for example, a smart phone) in various manners (for example, a head mount display provided with a dedicated slot); by means of wired or wireless connection with the mobile terminal, the mobile terminal performs calculations related to a virtual reality function and outputs data to the mobile virtual reality device, for example, watching a virtual reality video by an APP of the mobile terminal.
(2) An all-in-one virtual reality device, which has a processor for performing calculations related to a virtual function, and thus has independent virtual reality input and output functions, without the need of connection with a PC or a mobile terminal, with high use freedom.
(3) A personal computer VR (PCVR) device, which performs calculations related to a virtual reality function and data output by using a PC; the external personal computer VR device realizes the virtual reality effect by using the data output by the PC.

In the related art, the plurality of XR devices need sharing the same coordinate system based on one external base station, i.e., establishing a coordinate system by using a position of the base station as an origin, to measure their own poses with respect to the base station.

The solution in the related art needs additional deployment of the base station, so that sharing the same coordinate system by the plurality of VR devices is high in cost.

The method provided in the embodiment of the present application can be applied in a “large space” scene for a VR device, wherein the VR “large space” refers to that multiple persons can be accommodated simultaneously within one large space to perform some VR business, which is also called a multi-person VR scene. The VR “large space” enables a plurality of users to perform VR experience in one physical space simultaneously, and by transmitting, by a location technology, relative position information of a user in the physical space into a virtual scene, the user can see accurate positions of other users within the virtual scene, thereby reaching the effect of collaborative interaction between the plurality of users within the virtual scene.

According to the display method and apparatus, and the device, the medium, and the program provided in the embodiments of the present application, an XR device determines data of an environment map of a physical space and an association between a coordinate system of the environment map and a coordinate system of a virtual scene, obtains a first environment image of the physical space, and determines a first pose of the XR device under the coordinate system of the environment map according to the first environment image and the data of the environment map; calculates a second pose of the XR device under the coordinate system of the virtual scene according to the first pose and the association; and displays the virtual scene according to the second pose and the virtual scene. In this method, the XR device can obtain the association between the coordinate system of the environment map and the coordinate system of the virtual scene by itself and share the association to other XR devices, thereby realizing sharing of the coordinate system by multiple devices in the VR “large space” scene, without the need of an additional device to assist in the sharing of the coordinate system by multiple devices, which is a simple in implementation and reduces the cost of sharing the coordinate system by multiple devices.

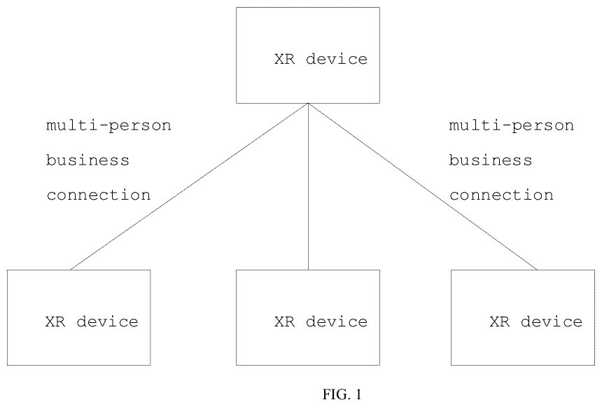

FIG. 1 is a schematic diagram of a multi-person VR scene applicable to an embodiment of the present application; as shown in FIG. 1, the scene includes four users, each user uses one XR device, the four XR devices are located in a same physical space, and the four XR devices can establish one multi-person business connection for jointly completing a multi-person business which may be a task that can be completed by a plurality of users on line simultaneously, such as a multi-person game, multi-person collaborative drawing, and multi-person collaborative design. The establishment of the multi-person business connection may be initiated by one of the users, and after the establishment of the multi-person business connection, the multi-person business may be started.

Taking a multi-person VR game scene as an example, a plurality of users, who wear respective XR devices, form a team in a living room for playing a game, one of the users can initiate an online invitation, and the other users accept the online invitation, so that a multi-person business connection is established.

In the multi-person VR scene, a relative spatial relation between the plurality of users in a physical space is consistent with a relative spatial relation between virtual users corresponding to the plurality of users in a 3D virtual scene, wherein the virtual users are in one-to-one correspondence with real users in the physical space, and a visual angle of the virtual user is consistent with that of the corresponding real user in the physical space. For example, a multi-person VR scene includes two users, the two users are face-to-face in a physical space, then virtual users corresponding to the two users are also face-to-face in a virtual scene, the two virtual users have different visual angles, the two virtual users see different pictures of the virtual scene, and accordingly, the users see, in the physical space, different pictures of the virtual scene through the XR devices.

In the VR “large space”, the physical space where the plurality of users are located is larger, so that the virtual scene is usually one virtual space generated by a designer, wherein, structures and a relative position relation of objects in the virtual space are matched with those of objects in the physical space. After entering the virtual scene, the users need to synchronize their own poses in the physical space into the virtual scene, wherein, the users have different poses in the physical space, and the users need to determine their own poses in the physical space based on a same coordinate system. The same coordinate system is also called a shared coordinate system, and sharing the coordinate system by multiple users refers to that multiple users use the same coordinate system, that is, multiple users determine their own poses in the same coordinate system (i.e., the same one coordinate system). In an actual scene, users and XR devices are bound, so that sharing the coordinate system by multiple users can also be understood as sharing the coordinate system by multiple devices, and a pose of the user in the coordinate system refers to a pose of a device used by the user in the coordinate system.

In the related art, it needs the help of another device for sharing the coordinate system by multiple devices, so that the cost of sharing the coordinate system by multiple devices is high. In order to solve the problem in the related art, an embodiment of the present application provides a display method, capable of achieving sharing of the coordinate system by multiple devices without the help of another device, reducing the cost of sharing the coordinate system by multiple devices.

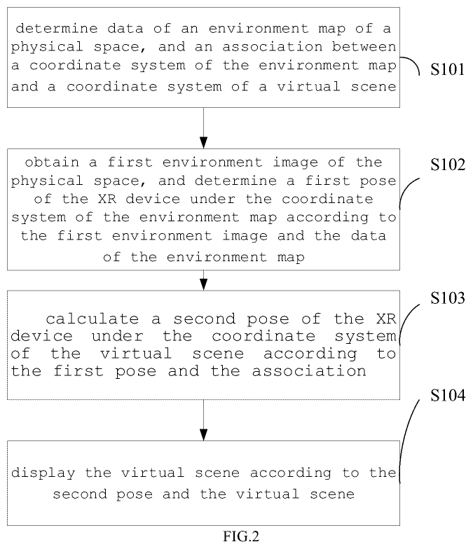

In conjunction with the scene shown in FIG. 1, the display method provided in the embodiment of the present application is described; FIG. 2 is a flow diagram of a display method according to a first embodiment of the present application, which may be executed by an XR device; the XR device may be any XR device in a multi-person VR scene, or a separate device independent of the multi-person VR scene, and the XR device does not participate in multi-person business; as shown in FIG. 2, the method in this embodiment comprises the following steps:

S101, determining data of an environment map of a physical space, and an association between a coordinate system of the environment map and a coordinate system of a virtual scene.

Taking an example that the XR device is any one of a plurality of XR devices in a VR “large space”, before the method of this embodiment is performed, a first XR device in the VR “large space” may establish a multi-person business connection, the plurality of XR devices corresponding to the multi-person business connection are located in a same physical space, and the first XR device is any one of the plurality of XR devices.

The multi-person business connection includes the plurality of XR devices; in an implementation, any one of the plurality of XR devices may initiate an online invitation, and the other XR devices accept the connection invitation, thereby completing the establishment of the multi-person business connection; the process of establishing the multi-person business connection is not described in detail in the embodiment of the present application, and reference may be made to the existing establishment of the multi-person business connection.

The multi-person business corresponds to a 3D virtual scene, which can be a VR scene and is shared by a plurality of users for interacting therewith. Taking a game scene as an example, the virtual scene is a game scene, and the users can play, execute corresponding tasks and the like in the game scene.

The environment map can be established by any one of the plurality of XR devices and shared to the other XR devices, and the environment map is used for the plurality of XR devices to respectively determine their own poses in the coordinate system of the environment map.

After the multi-person business connection is established, a certain device may be specified according to a rule to establish the environment map, or a certain device may be pre-configured to establish the environment map, for example, an initiator of the multi-person business connection is configured to establish the environment map.

Accordingly, the XR device may determine the data of the environment map of the physical space in the following manners:

In a first manner, the XR device acquires a plurality of second environment images of the physical space, and generates the environment map of the physical space according to the plurality of second environment images of the physical space. After generating the environment map, the XR device stores the data of the environment map locally, and sends the data of the environment map to the other XR devices in the plurality of XR device, so that the plurality of XR device in the multi-person business can all obtain the environment map.

The physical space is a real physical space (or called a real scene) where the multi-person business connection is located, which may be a room, a living room, a game room, and the like. The user, who wears the XR device, moves in the physical space, and acquires the plurality of second environment images of the physical space by a camera of the XR device, the plurality of second environment images covering positions of the physical space. The XR device can establish the environment map corresponding to the physical space according to pose information of the camera and the plurality of second environment images captured by the camera.

In a second manner, the XR device receives data of an environment map sent by another one of the plurality of XR devices, for example, the environment map is generated by a second XR device, and after generating the environment map, the second XR device sends the environment map to others of the plurality of XR devices, so that the plurality of XR devices in the multi-person business can all obtain the environment map.

The second XR device and the XR device establish the environment map by using the same method, and the XR device or the second XR device may acquire an environment image of the physical space in real time and generate the environment map after the multi-person business connection.

In a third manner, if the XR device or second XR device has already generated the environment map for the physical space before, there is no need to generate the environment map repeatedly, so that the XR device or second XR device only needs to retrieve the environment map to use it.

Optionally, between the plurality of XR devices, the data may be transmitted by short-range communication, which includes but is not limited to blue tooth, wireless fidelity (Wi-Fi for short), infrared data transmission, ZigBee, and the like.

In one implementation, the XR device sends the environment map to the other XR devices by the short-range communication connection. In another implementation, the XR device establishing the environment map sends the environment map to a server, the plurality of XR devices in the VR “large space” all establish a connection and communicate with the server, and the other XR devices may actively request the environment map from the server, or after receiving the environment map sent by the XR device establishing the environment map, the server actively sends the environment map to the other XR devices. Optionally, a local server or a cloud server may be adopted for the server.

The data of the environment map includes visualization information of the physical space, which includes pixel coordinates of feature points of frames of images on the map, 3D coordinates of the feature points, descriptors of the feature points, and the like. The frames of images in the map are divided into regular frames and key frames.

The feature point of the image refers to a point where there is a drastic change in a gray value of the image or a point with a great curvature on an edge of the image (i.e., an intersection between two edges), so that the feature point is a 2D point, and a position of the feature point may be represented by a pixel coordinate of the image where the feature point is located (i.e., the image where the feature point is extracted).

The 3D coordinate of the feature point refers to a 3D coordinate of the feature point in the physical space, wherein feature points in different images may correspond to a same 3D point in the physical space. The 3D coordinate of the feature point may also be understood as one map point, which is a 3D point that comes from a real object in the physical space and may have a unique ID.

The descriptor of the feature point is used for describing an already detected feature point and is a binary coded descriptor. The descriptor can be used for describing information around the feature point, for example, a geometric feature around the feature point, and a common descriptor is a binary robust independent elementary feature (BRIEF for short) descriptor.

Optionally, the XR device may establish the environment map of the physical space by using a simultaneous localization and mapping (SLAM for short) algorithm, in which a map and structure in an unknown environment are constructed by using a sensor, and a position and direction of the device are localized, with related steps including: the sensor reading/laser scanning data such as a video image or point cloud; estimating, by a front-end visual odometry (VO for short), pose changes of a camera at two time instants, through algorithms such as feature matching, direct registration; receiving, at a back end, the camera poses measured by the visual odometry at different time instants, and after the camera poses are optimized, obtaining globally consistent trajectories and maps, with loop detection, processing of accumulated errors, map establishment and the like involved in the process.

VIO-SLAM, on the basis of a visual-inertial odometry (VIO for short), also known as a visual-inertial system (VINS for short), fuses camera and IMU data for SLAM, and can improve the performance of the SLAM algorithm.

Exemplarily, the XR device extracts feature points in the second environment image of the physical space, determines pixel coordinates of the feature points, and calculates descriptors of the feature points, calculates 3D coordinates of the feature points according to the pixel coordinates of the feature points, and establishes the environment map according to the pixel coordinates, the descriptors and the 3D coordinates of the feature points.

The XR device may perform feature point extraction on the image by using a feature extractor, which may be a function of performing feature extraction on the image, and the feature extracted by the function is represented using a feature vector. The feature extractor may also be a neural network, including, but not limited to: convolutional neural network (CNN for short), multi-layer perceptron neural network (MLP for short), Transformer-structured neural network, and the like.

Exemplarily, the position of the feature point may be detected by using an algorithm such as a FAST feature point detection algorithm, or a Harris corner point detection algorithm, or scale-invariant feature transform (SIFT for short), speeded up robust feature (SURF for short). After the position of the feature point (i.e., a pixel coordinate of the feature point) is detected, the descriptor of the feature point is calculated.

After the pixel coordinate of the feature point is determined, the 3D coordinate of the feature point may be calculated by a triangulation method, or by a depth map, which is merely exemplified, and the method for calculating the 3D coordinate of the feature point is not limited in the embodiment of the present application.

In the process of establishing the environment map of the physical space, the coordinate system of the environment map is established firstly, which is uniquely determined by an origin of the environment map and a direction of a coordinate axis. The XR device may select a certain 3D point in the physical space as the origin of the coordinate system, and specify the direction of the coordinate axis, and generate the data of the environment map according to the established coordinate system of the environment map.

After determining the data of the environment map of the physical space, the XR device may determine an association between the coordinate system of the environment map and the coordinate system of the 3D virtual scene according to an input of the user, the association is an offset between the coordinate system of the virtual scene and the coordinate system of the environment map, the coordinate system of the virtual scene has been already determined when the virtual scene is established, while the coordinate system of the environment map is determined by the XR device itself when generating the environment map; the coordinate system of the environment map may not be an ideal coordinate system expected by the user, and the ideal coordinate system can better present the content of the virtual scene, therefore in this embodiment, the coordinate system of the environment map is adjusted, so that the adjusted coordinate system of the environment map is the ideal coordinate system expected by the user.

The offset between the coordinate system of the environment map and the coordinate system of the virtual scene includes rotation information and/or translation information of the coordinate system, wherein, the translation information refers to movement distances of the coordinate system on X, Y, Z axes, and the rotation information refers to rotation angles of the coordinate system on the X, Y, Z axes.

The offset between the coordinate system of the environment map and the coordinate system of the virtual scene may be represented by a matrix or Euclidean transformation, or in other forms, which is not limited in the embodiment of the present application.

Associating the coordinate system of the environment map with the coordinate system of the virtual scene may be understood as binding the coordinate system of the environment map with the coordinate system of the 3D virtual scene, by which the pose of the XR device in the physical space is synchronized with a pose of a virtual character corresponding to the XR device in the virtual scene; when the pose of the XR device in the physical space changes, the pose of the virtual character corresponding to the XR device in the virtual scene also changes accordingly, or the virtual character follows the XR device for motion, the motion of the XR device including movement and/or rotation, so that the user can adjust the pose of the virtual character corresponding to the XR device by adjusting the pose of the XR device.

In one implementation, the XR device determines the association between the coordinate system of the environment map and the coordinate system of the virtual scene according to a first point in the physical space determined by the user. Specifically, the first point determined by the user is associated with a coordinate origin of the virtual scene, that is, the first point in the environment map is taken as the origin of the coordinate system of the virtual scene. The user may indicate a position of the first point in various input modes, for example, a ray emitted by a controller (e.g., a handle) of the XR device may be displayed, an intersection between the ray and a ground at a certain time instant is determined as the position of the first point, or the first point is determined by a position of gaze of the user in conjunction with another operation, or the first point is determined by a voice input of the user in conjunction with semantic identification on the environment image, or the like, and the manner of determining the first point is not limited in the embodiment of the present application.

In the coordinate system, in addition to the origin, a direction needs to be defined, and the direction may be pre-specified or determined by an input of the user; for example, after the origin is selected, an adjustable arrow is displayed in a direction parallel to the ground (i.e., perpendicular to gravity), a direction of the arrow is adjusted based on the input of the user, and the direction of the coordinate system is determined according to the adjusted direction of the arrow, and the manner of determining the direction of the coordinate system is not limited in the embodiment of the present application.

Optionally, in the process of obtaining the input of the user, the XR device may work in a perspective mode, i.e., the image of the physical space is, after being obtained and processed, displayed on the XR device, enabling the user to see the physical space, which more facilitates the input.

Optionally, at the first point in the physical space, a physical mark is provided, which is used for prompting that the user can determine a position where the physical mark is located as the first point, or the first point in the physical space is a corner point, which may be understood as a corner point of a wall or a table in the physical space that may generally be an intersection of two or three lines perpendicular to each other in the space; there may be a plurality of corner points in the physical space, and the user may indicate a position of one corner point in the physical space by a controller of the XR device, and take the indicated corner point as the first point.

Optionally, determining, by the XR device, the association between the coordinate system of the environment map and the coordinate system of the virtual scene according to the first point in the physical space determined by the user, may specifically be realized in the following two manners: (1) determining the association between the coordinate system of the environment map and the coordinate system of the virtual scene according to the first point and a direction in the physical space determined by the user; and (2) determining the association between the coordinate system of the environment map and the coordinate system of the virtual scene according to the first point and a second point in the physical space determined by the user.

In the manner (1), the user indicates not only the first point but also the direction, the first point and the direction being an origin and direction of the adjusted coordinate system of the environment map, and then, according to the origin and direction of the adjusted coordinate system of the environment map and the origin and direction of the coordinate system of the virtual scene, the offset between the coordinate system of the environment map and the coordinate system of the virtual scene is determined.

In the manner (2), the user indicates an origin and direction of the adjusted coordinate system of the environment map by indicating two points, wherein the first point is the origin of the adjusted coordinate system of the environment map, and a direction from the first point to the second point is a direction of any coordinate axis of the adjusted coordinate system of the environment map.

Optionally, the XR device may further determine the association between the coordinate system of the environment map and the coordinate system of the virtual scene according to a preset mark identified in at least one second environment image. By identifying the preset mark, the position of one origin can be obtained, and optionally, the direction can also be obtained.

Exemplarily, the preset mark can be one “ [symbol] ” character located on the ground in the physical space, or a device having a special light spot (like a VR handle, a pose can be identified if there is a light spot), and the position of one origin and the direction are determined according to optical identification of the “ [symbol] ” character mark or the light spot. For example, the “ [symbol] ” character mark is identified, a connection point between two strokes of the “ [symbol] ” character mark is taken as the origin, and directions where the two strokes are located are taken as the directions of two coordinate axes of the coordinate system.

S102, obtaining a first environment image of the physical space, and determining a first pose of the XR device under the coordinate system of the environment map according to the first environment image and the data of the environment map.

The plurality of XR devices corresponding to the multi-person business connection share the environment map, and the environment map is used by the plurality of XR devices to respectively determine their own first poses under the coordinate system of the environment map, and the plurality of XR devices determine their own poses under the coordinate system of the environment map based on the same environment map, thereby sharing the coordinate system by the plurality of devices, the plurality of XR devices having the same method for determining the first pose.

The first environment image is an environment image captured by the XR device in real time through a camera, and the first pose of the XR device is data with 6 dimensions of freedom (6DOF for short), including the position and attitude of the XR device.

Exemplarily, the XR device extracts feature points in the first environment image, calculates descriptors of the feature points in the first environment image, matches the descriptors of the feature points in the first environment image with the descriptors of the feature points in the environment map, and performs pose solution according to 3D coordinates, the pixel coordinates in the first environment image, and the pixel coordinates in the environment map of matched feature points, to obtain the first pose of the XR device under the coordinate system of the environment map.

The XR device may adopt any existing feature point matching algorithm for the match of the feature points of the first environment image and the feature points of the environment map, and common feature point matching algorithms include, but are not limited to: brute force matching, cross matching, RANdom SAmple Consensus (RANSAC for short), etc.

The XR device may determine the first pose of the XR device under the coordinate system of the environment map by using any existing pose solution method, which is not limited in this embodiment.

Exemplarily, the XR device may solve a matching result by using a perspective-n-point (PnP for short) algorithm, which is a method for solving 3D-2D point pair motion, and describes how to estimate a pose of the camera (i.e., the first pose of the XR device) when coordinates of n 3D points and pixel coordinates of these points are given, where n has a value greater than or equal to 2, exemplarily, 3 or 5.

By sharing, between the plurality of XR devices, the environment image of the physical space where they are located, the devices determine their own first poses under the coordinate system of the environment map based on the shared environment map and the current environment images captured by themselves, thereby sharing the coordinate system by the plurality of devices, and this does not need an additional device to assist, so that it is simple in implementation and reduce the cost of sharing the coordinate system by the plurality of devices.

S103, calculating a second pose of the XR device under the coordinate system of the virtual scene according to the first pose and the association.

The association may be the offset between the coordinate system of the environment map and the coordinate system of the virtual scene, the offset including rotation information and/or translation information of the coordinate system.

When creating the environment map, the XR device generates the origin and direction of the coordinate system of the environment map, determines the association according to the input of the user and stores the association, and subsequently, when obtaining the environment map, the other XR devices will also obtain the association simultaneously, and determine their own second poses under the coordinate system of the virtual scene according to the association.

Exemplarily, the second pose of the XR device under the coordinate system of the virtual scene is calculated by:

T_{b}^{W′}=T_{offset}T_{b}^{W}
where T_{offset} represents the association (i.e., the offset between the coordinate system of the environment map and the coordinate system of the virtual scene), T_{b}^{W} represents the first pose of the XR device under the coordinate system of the environment map, T_{b}^{W′} represents the second pose of the XR device under the coordinate system of the virtual scene, the first pose and the second pose being both data of 6DOf, which contains the rotation information and translation information of the XR device, and can be represented by Euclidean transformation or other forms.

S104, displaying the virtual scene according to the second pose and the virtual scene.

In one implementation, the XR device renders the virtual scene according to the second pose to obtain a rendering result, and displays the rendering result of the virtual scene. In the implementation, local rendering is performed by the XR device through a rendering engine, and the rendering result is displayed on a screen after the rendering.

In another implementation, the XR device sends the second pose to a rendering device, and receives a rendering result of the virtual scene sent by the rendering device, the rendering result being obtained by the rendering device rendering the virtual scene according to the second pose. In the implementation, the virtual scene is rendered by a remote server, which may be a cloud rendering server.

Optionally, after calculating the second pose, the XR device sends the second pose to the other devices in the physical space, so that the other devices in the physical space display a virtual object corresponding to the XR device according to the second pose, wherein the virtual object may be the virtual character corresponding to the XR device.

Optionally, the virtual scene is matched with the physical space; the virtual scene being matched with the physical space in the VR “large space” refers to that an internal structure and external contour of the virtual scene are the same as or corresponding to those of the physical space, and structures and position relations of virtual objects in the virtual scene are the same as those of entity objects in the physical space. When the users move in the physical space, the virtual characters corresponding to the users correspondingly move in the virtual scene, and relative position relations between the users in the physical space are consistent with relative position relations between the virtual characters corresponding to the users in the virtual scene.

According to the method of this embodiment, an XR device determines data of an environment map of a physical space, and an association between a coordinate system of the environment map and a coordinate system of a virtual scene, obtains a first environment image of the physical space, and determines a first pose of the XR device under the coordinate system of the environment map according to the first environment image and the data of the environment map; calculates a second pose of the XR device under the coordinate system of the virtual scene according to the first pose and the association; and displays the virtual scene according to the second pose and the virtual scene. In this method, the XR device can obtain the association between the coordinate system of the environment map and the coordinate system of the virtual scene by itself and share the association to other XR devices, thereby achieving the sharing of the coordinate system by multiple devices in the VR “large space” scene, without the need for an additional device to assist in the sharing of the coordinate system by multiple devices, which is simple in implementation and reduces the cost of sharing the coordinate system by multiple devices.

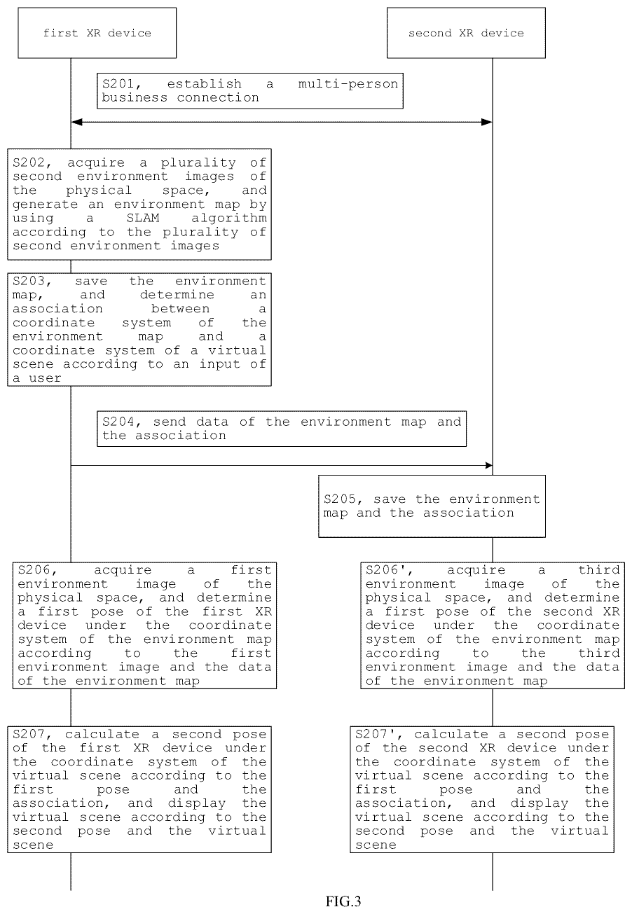

On the basis of the first embodiment, a second embodiment of the present application provides a display method, and takes two devices as an example for illustration. FIG. 3 is a signaling flow diagram of a display method according to the second embodiment of the present application, and as shown in FIG. 3, the method provided in the second embodiment comprises the following steps.

S201, establishing, by a first XR device and a second XR device, a multi-person business connection.

The first XR device and the second XR device are located in a same physical space; as can be understood, the multi-person business connection may be established between the first XR device and the second XR device by one or more pieces of information.

S202, acquiring, by the first XR device, a plurality of second environment images of the physical space, and generating an environment map by using an SLAM algorithm according to the plurality of second environment images.

The first XR device moves in the physical space, and captures a plurality of frames of environment images of the physical space by a camera, the plurality of frames of environment images having different camera poses. The first XR device extracts feature points in the image of the physical space, determines pixel coordinates of the feature points, and calculates descriptors of the feature points, calculates 3D coordinates of the feature points according to the pixel coordinates of the feature points, and establishes the environment map according to the pixel coordinates, the descriptors and the 3D coordinates of the feature points.

S203, saving, by the first XR device, the environment map, and determining an association between a coordinate system of the environment map and a coordinate system of a virtual scene according to an input of a user.

The virtual scene is a 3D virtual scene corresponding to the multi-person business, and the first XR device and the second XR device access the virtual scene by the multi-person business connection.

S204, sending, by the first XR device, data of the environment map and the association to the second XR device.

The data of the environment map includes information of the coordinate system of the environment map, the 3D coordinates of the feature points in the environment map, the pixel coordinates of the feature points, the descriptors of the feature points, and the like.

It should be noted that, the step S201 may be executed before or after the step S202, for example, the first device executes the steps S202 and S203, then executes the step S201 to establish a multi-person business connection with the second XR device, and then, sends data of the environment map and the association to the second XR device by the multi-person business connection.

In addition, the first XR device and the second XR device may establish the connection directly or by a server. After the first XR device and the second XR device establish the connection directly, the first XR device may send the data of the environment map and the association by the directly established connection. When the first XR device and the second XR device establish the connection by the server, the first XR device sends the data of the environment map and the association to the server, and the data of the environment map and the association are sent to the second XR device by the server.

S205, saving, by the second XR device, the environment map and the association.

The second XR device receives the environment map and the association sent by the first XR device, and stores the environment map and the association, the environment map being used for subsequently determining its own pose under the coordinate system of the environment map.

S206, acquiring, by the first XR device, a first environment image of the physical space, and determining a first pose of the first XR device under the coordinate system of the environment map according to the first environment image and the data of the environment map.

Exemplarily, the first XR device extracts feature points in the first environment image, calculates descriptors of the feature points in the first environment image, matches the descriptors of the feature points in the first environment image with the descriptors of the feature points in the environment map, and performs pose solution according to 3D coordinates, pixel coordinates in the first environment image, and pixel coordinates in the environment map of matched feature points, to obtain a pose of the first XR device under the coordinate system of the environment map.

S207, calculating, by the first XR device, a second pose of the first XR device under the coordinate system of the virtual scene according to the first pose and the association, and displaying the virtual scene according to the second pose and the virtual scene.

S206′, acquiring, by the second XR device, a third environment image of the physical space, and

determining a first pose of the second XR device under the coordinate system of the environment map according to the third environment image and the data of the environment map.

Exemplarily, the second XR device extracts feature points in the third environment image, calculates descriptors of the feature points in the third environment image, matches the descriptors of the feature points in the third environment image with the descriptors of the feature points in the environment map, and performs pose solution according to 3D coordinates, pixel coordinates in the third environment image, and pixel coordinates in the environment map of matched feature points, to obtain a first pose of the second XR device under the coordinate system of the environment map.

S207′, calculating, by the second XR device, a second pose of the second XR device under the coordinate system of the virtual scene according to the first pose and the association, and displaying the virtual scene according to the second pose and the virtual scene.

It should be noted that the steps S206 and S207 are executed in parallel with the steps S206′ and S207′, that is, the two XR devices locate their own poses in parallel.

The first environmental image is captured by the camera of the first XR device, the third environmental image is captured by the camera of the second XR device, and the first XR device and the second XR device have different poses, and therefore, the first environmental image and the third environmental image are different. The two XR devices respectively perform camera pose solution according to the captured environment image and the environment map to obtain their own first poses under the coordinate system of the environment map, and determine their own second poses under the coordinate system of the virtual scene according to their own first poses and the association, and render the image of the virtual scene according to the second poses, so that a relative position relation between the two XR devices in the physical space is consistent with a relative position relation between virtual characters corresponding to the two XR devices in the virtual scene.

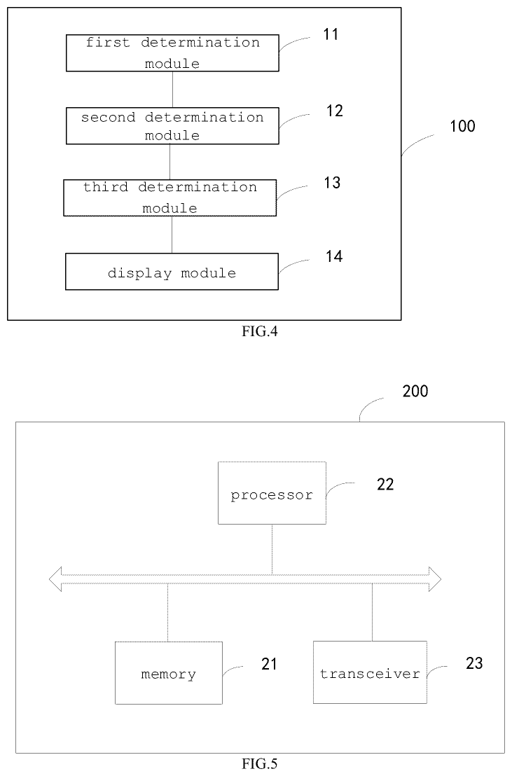

In order to facilitate better implementation of the display method of the embodiment of the present application, an embodiment of the present application further provides a display apparatus. FIG. 4 is a schematic structural diagram of a display apparatus according to a third embodiment of the present application, and as shown in FIG. 4, the display apparatus 100 may comprise:
a first determination module 11, configured to determine data of an environment map of a physical space, and an association between a coordinate system of the environment map and a coordinate system of a virtual scene;
a second determination module 12, configured to obtain a first environment image of the physical space, and determine a first pose of an extended reality XR device under the coordinate system of the environment map according to the first environment image and the data of the environment map;
a third determination module 13, configured to calculate a second pose of the XR device under the coordinate system of the virtual scene according to the first pose and the association; and
a display module 14, configured to display the virtual scene according to the second pose and the virtual scene.

In some optional implementations, the apparatus further comprises a fourth determination module configured to:
acquire a plurality of second environment images of the physical space, and generate the environment map of the physical space according to the plurality of second environment images; and
determine the association between the coordinate system of the environment map and the coordinate system of the virtual scene according to an input of a user, or determine the association between the coordinate system of the environment map and the coordinate system of the virtual scene according to a preset mark identified in at least one second environment image.

In some optional implementations, the fourth determination module is specifically configured to: determine the association between the coordinate system of the environment map and the coordinate system of the virtual scene according to a first point in the physical space determined by the user.

In some optional implementations, the fourth determination module is specifically configured to: determine the association between the coordinate system of the environment map and the coordinate system of the virtual scene according to the first point and a direction in the physical space determined by the user;
or, determine the association between the coordinate system of the environment map and the coordinate system of the virtual scene according to the first point and a second point in the physical space determined by the user.

In some optional implementations, a physical mark is provided at the first point in the physical space, or the first point in the physical space is a corner point.

In some optional implementations, the virtual scene is matched with the physical space.

In some optional implementations, the apparatus further comprises a sending module configured to: send the second pose, so that another device in the physical space displays a virtual object corresponding to the XR device according to the second pose.

In some optional implementations, the apparatus further comprises a sending module configured to: send the association to another device in the physical space, so that the other device determines its pose under the coordinate system of the environment map according to the association and the environment image of the physical space.

In some optional implementations, the data of the environment map comprises three-dimensional coordinates of feature points in the environment map, pixel coordinates of the feature points, and descriptors of the feature points; and
the second determination module 12 is specifically configured to:
extract feature points in the first environment image, and calculate descriptors of the feature points in the first environment image;
match the descriptors of the feature points in the first environment image with the descriptors of the feature points in the environment map; and
perform pose solution according to three-dimensional coordinates, pixel coordinates in the first environment image, and pixel coordinates in the environment map of matched feature points, to obtain a first pose of the XR device under the coordinate system of the environment map.

In some optional implementations, the XR device performs the pose solution by using a perspective-n-point PnP algorithm.

In some optional implementations, the fourth determination module is specifically configured to:
extract feature points in the second environment image, determine pixel coordinates of the feature points, and calculate descriptors of the feature points;
calculate three-dimensional coordinates of the feature points according to the pixel coordinates of the feature points; and
establish the environment map according to the pixel coordinates, the descriptors, and the three-dimensional coordinates of the feature points.

It should be understood that the apparatus embodiments and the method embodiments may correspond to each other, so that similar descriptions may refer to the method embodiments. To avoid repetition, the descriptions are omitted here.

The apparatus 100 of the embodiment of the present application has been described above in conjunction with the drawings from the perspective of functional blocks. It should be understood that the functional modules may be implemented by hardware, or by instructions in the form of software, or by a combination of hardware and software modules. Specifically, the steps of the method embodiments in the embodiments of the present application may be implemented by integrated logic circuits of hardware in a processor and/or instructions in the form of software, and the steps of the method disclosed in conjunction with the embodiments of the present application may be directly executed by a hardware decoding processor, or by a combination of hardware and software modules in a decoding processor. Optionally, the software modules may be located in a random access memory, flash memory, read-only memory, programmable read-only memory, electrically erasable programmable memory, register, or other developed storage media in the art. The storage medium is located in a memory, and a processor reads information in the memory and completes the steps in the above method embodiments in conjunction with hardware thereof.

An embodiment of the present application further provides an XR device. FIG. 5 is a schematic structural diagram of an XR device according to a fourth embodiment of the present application, and as shown in FIG. 5, the XR device 200 may comprise:
a memory 21 and a processor 22, the memory 21 being configured to store a computer program and transmit code of the program to the processor 22. In other words, the processor 22 may call and run a computer program from the memory 21, to implement the method in the embodiment of the present application.

For example, the processor 22 may be configured to perform the above method embodiments according to instructions in the computer program.

In some embodiments of the present application, the processor 22 may include, but is not limited to: a general-purpose processor, digital signal processor (DSP), application specific integrated circuit (ASIC), field programmable gate array (FPGA) or other programmable logic devices, discrete gate or transistor logic device, discrete hardware component, and the like.

In some embodiments of the present application, the memory 21 includes, but is not limited to: a volatile memory and/or non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external cache. By exemplary but not limitative illustration, many forms of RAMs are available, for example, static RAM (SRAM), dynamic RAM (DRAM), synchronous DRAM (SDRAM), double data rate SDRAM (DDR SDRAM), enhanced SDRAM (ESDRAM), synch link DRAM (SLDRAM), and direct rambus RAM (DR RAM).

In some embodiments of the present application, the computer program may be divided into one or more modules, which are stored in the memory 21 and executed by the processor 22, to accomplish the method provided in the present application. The one or more modules may be a series of computer program instruction segments capable of accomplishing specific functions, which are used for describing the execution process of the computer program in the XR device.

As shown in FIG. 5, the XR device 200 may further comprise: a transceiver 23 connectable to the processor 22 or the memory 21.

The processor 22 may control the transceiver 23 to communicate with another device, and specifically, may send information or data to the other device or receive information or data sent by the other device. The transceiver 23 may include a transmitter and a receiver. The transceiver 23 may further include antennas, the number of which may be one or more.

It can be understood that although not shown in FIG. 5, the XR device 200 may further include a camera module, a wireless fidelity (WIFI) module, a location module, a Bluetooth module, a display, a controller, etc., which are not repeated here.

It should be understood that the various components in the XR device are connected by a bus system, wherein the bus system includes a power bus, a control bus, and a status signal bus, in addition to a data bus.

The present application further provides a computer storage medium having thereon stored a computer program which, when executed by a computer, causes the computer to perform the method of the above method embodiments. Alternatively, an embodiment of the present application further provides a computer program product containing instructions which, when executed by a computer, cause the computer to perform the method of the above method embodiments.

The present application further provides a computer program product, comprising a computer program stored in a computer-readable storage medium. A processor of the XR device reads the computer program from the computer-readable storage medium, and the processor executes the computer program, so that the XR device executes the corresponding processes in the method embodiments, which are not repeated here for brevity.

In the several embodiments provided in the present application, it should be understood that the disclosed system, apparatus and method may be implemented in other manners. For example, the above described apparatus embodiments are merely illustrative, for example, the division of the modules is only a logical function division, and in practical implementations, there may be other divisions, for example, a plurality of modules or components may be combined or integrated into another system, or some features may be omitted, or not executed. In addition, the displayed or discussed mutual coupling or direct coupling or communication connection may be indirect coupling or communication connection through some interfaces, devices or modules, which may be in electrical, mechanical or other forms.

Modules described as separate parts may or may not be physically separated, and parts displayed as modules may or may not be physical modules, that is, they may be located in one place or distributed onto a plurality of network units. The purpose of the solution of this embodiment may be implemented by selecting some or all of the modules according to actual needs. For example, functional modules in the embodiments of the present application may be integrated into one processing module, or the modules may exist separately physically, or two or more modules are integrated into one module.

The above is only the specific implementations of the present application, but the scope of protection of the present application is not limited thereto, and any person skilled in the art can, within the technical scope disclosed in the present application, easily think of changes or substitutions, which should all be covered within the scope of protection of the present application. Therefore, the scope of protection of the present application shall be subject to the scope of protection of the claims.

What is claimed is:

1. A display method comprising:
determining data of an environment map of a physical space, and an association between a coordinate system of the environment map and a coordinate system of a virtual scene;
obtaining a first environment image of the physical space, and determining a first pose of an extended reality XR device under the coordinate system of the environment map according to the first environment image and the data of the environment map;
calculating a second pose of the XR device under the coordinate system of the virtual scene according to the first pose and the association; and
displaying the virtual scene according to the second pose and the virtual scene.

2. The method according to claim 1, wherein before the determining data of an environment map of a physical space, and an association between a coordinate system of the environment map and a coordinate system of a virtual scene, the method further comprises:
acquiring a plurality of second environment images of the physical space, and generating the environment map of the physical space according to the plurality of second environment images; and
determining the association between the coordinate system of the environment map and the coordinate system of the virtual scene according to an input of a user, or determining the association between the coordinate system of the environment map and the coordinate system of the virtual scene according to a preset mark identified in at least one second environment image.

3. The method according to claim 2, wherein the determining the association between the coordinate system of the environment map and the coordinate system of the virtual scene according to an input of a user, comprises:
determining the association between the coordinate system of the environment map and the coordinate system of the virtual scene according to a first point in the physical space determined by the user.

4. The method according to claim 3, wherein the determining the association between the coordinate system of the environment map and the coordinate system of the virtual scene according to a first point in the physical space determined by the user, comprises:
determining the association between the coordinate system of the environment map and the coordinate system of the virtual scene according to the first point and a direction in the physical space determined by the user;
or, determining the association between the coordinate system of the environment map and the coordinate system of the virtual scene according to the first point and a second point in the physical space determined by the user.

5. The method according to claim 3, wherein a physical marker is provided at the first point in the physical space, or the first point in the physical space is a corner point.

6. The method according to claim 1, wherein the virtual scene is matched with the physical space.

7. The method according to claim 1, wherein after the calculating a second pose of the XR device under the coordinate system of the virtual scene according to the first pose and the association, the method further comprises:
sending the second pose, so that another device in the physical space displays a virtual object corresponding to the XR device according to the second pose.

8. The method according to claim 2, wherein after the determining the association between the coordinate system of the environment map and the coordinate system of the virtual scene according to an input of a user, the method further comprises:
sending the association to another device in the physical space, so that the other device determines its pose under the coordinate system of the environment map according to the association and the environment image of the physical space.

9. The method according to claim 1, wherein the data of the environment map comprises three-dimensional coordinates of feature points in the environment map, pixel coordinates of the feature points, and descriptors of the feature points; and
the determining a first pose of the XR device under the coordinate system of the environment map according to the first environment image and the data of the environment map, comprises:
extracting feature points in the first environment image, and calculating descriptors of the feature points in the first environment image;
matching the descriptors of the feature points in the first environment image with the descriptors of the feature points in the environment map; and
performing pose solution according to three-dimensional coordinates, pixel coordinates in the first environment image, and pixel coordinates in the environment map of matched feature points, to obtain the first pose of the XR device under the coordinate system of the environment map.

10. The method according to claim 9, wherein the XR device performs the pose solution by using a perspective-n-point PnP algorithm.

11. The method according to claim 2, wherein the generating the environment map of the physical space according to the second environmental image, comprises:
extracting feature points in the second environment image, determining pixel coordinates of the feature points, and calculating descriptors of the feature points;
calculating three-dimensional coordinates of the feature points according to the pixel coordinates of the feature points; and
establishing the environment map according to the pixel coordinates, the descriptors and the three-dimensional coordinates of the feature points.

12. An extended reality device comprising:
a processor and a memory, the memory being configured to store a computer program, the processor being configured to call and run the computer program stored in the memory to perform a display method comprising:
determining data of an environment map of a physical space, and an association between a coordinate system of the environment map and a coordinate system of a virtual scene;
obtaining a first environment image of the physical space, and determining a first pose of an extended reality XR device under the coordinate system of the environment map according to the first environment image and the data of the environment map;
calculating a second pose of the XR device under the coordinate system of the virtual scene according to the first pose and the association; and
displaying the virtual scene according to the second pose and the virtual scene.

13. The device according to claim 12, wherein before the determining data of an environment map of a physical space, and an association between a coordinate system of the environment map and a coordinate system of a virtual scene, the method further comprises:
acquiring a plurality of second environment images of the physical space, and generating the environment map of the physical space according to the plurality of second environment images; and
determining the association between the coordinate system of the environment map and the coordinate system of the virtual scene according to an input of a user, or determining the association between the coordinate system of the environment map and the coordinate system of the virtual scene according to a preset mark identified in at least one second environment image.

14. The device according to claim 13, wherein the determining the association between the coordinate system of the environment map and the coordinate system of the virtual scene according to an input of a user, comprises:
determining the association between the coordinate system of the environment map and the coordinate system of the virtual scene according to a first point in the physical space determined by the user.

15. The device according to claim 14, wherein the determining the association between the coordinate system of the environment map and the coordinate system of the virtual scene according to a first point in the physical space determined by the user, comprises:
determining the association between the coordinate system of the environment map and the coordinate system of the virtual scene according to the first point and a direction in the physical space determined by the user;
or, determining the association between the coordinate system of the environment map and the coordinate system of the virtual scene according to the first point and a second point in the physical space determined by the user.

16. The device according to claim 14, wherein a physical marker is provided at the first point in the physical space, or the first point in the physical space is a corner point.

17. The device according to claim 12, wherein the virtual scene is matched with the physical space.

18. The device according to claim 12, wherein after the calculating a second pose of the XR device under the coordinate system of the virtual scene according to the first pose and the association, the method further comprises:
sending the second pose, so that another device in the physical space displays a virtual object corresponding to the XR device according to the second pose.

19. A non-transitory computer-readable storage medium, characterized by storing a computer program, causing a computer to perform a display method comprising:
determining data of an environment map of a physical space, and an association between a coordinate system of the environment map and a coordinate system of a virtual scene;
obtaining a first environment image of the physical space, and determining a first pose of an extended reality XR device under the coordinate system of the environment map according to the first environment image and the data of the environment map;
calculating a second pose of the XR device under the coordinate system of the virtual scene according to the first pose and the association; and
displaying the virtual scene according to the second pose and the virtual scene.

20. The medium according to claim 19, wherein before the determining data of an environment map of a physical space, and an association between a coordinate system of the environment map and a coordinate system of a virtual scene, the method further comprises: acquiring a plurality of second environment images of the physical space, and generating the environment map of the physical space according to the plurality of second environment images; and
determining the association between the coordinate system of the environment map and the coordinate system of the virtual scene according to an input of a user, or determining the association between the coordinate system of the environment map and the coordinate system of the virtual scene according to a preset mark identified in at least one second environment image.
